(19) United States
(12) Patent Application Publication
(10) Pub. No.: US 2025/0132602 A1
(43) Pub. Date: Apr. 24, 2025

(54) WIRELESS CHARGING DEVICE

(71) Applicant: Lanto Electronic Limited, Kunshan City (CN)

(72) Inventors: SHENG-WEN WU, Kunshan City (CN); CHANG SING CHU, Kunshan City (CN); CHUNG HUNG LI, Kunshan City (CN); CHENG YO SIAO, Kunshan City (CN); YU FENG HUANG, Kunshan City (CN); CHIA WEI CHOU, Kunshan City (CN)

(73) Assignee: Lanto Electronic Limited, Kunshan City (CN)

(21) Appl. No.: 18/804,566

(22) Filed: Aug. 14, 2024

(30) Foreign Application Priority Data
Oct. 20, 2023 (CN) 202311369040.9

(51) Int. Cl. H02J 50/00; H02J 50/10; H02J 50/40; H02J 50/90

(52) U.S. Cl. CPC H02J 50/005; H02J 50/10; H02J 50/402; H02J 50/90

(57) ABSTRACT

A wireless charging device is disclosed. At least one floating charging component is arranged in the wireless charging device, the floating charging component comprises a supporting plate, a power transmission coil, and a magnetic element, the top wall of a housing is provided with at least one mounting hole, and the floating charging component is movably arranged in the mounting hole, so that when the device to be charged is placed on a bearing surface of the top wall, the magnetic element is able to attract the device to be charged so that the outer surface of the supporting plate contacts with the device to be charged, so that ensures that the power transmission coil and the device to be charged be aligned with each other and the distance between them is small, thereby ensuring the wireless charging rate.

### CLAIM OF PRIORITY and CROSS-REFERENCE TO RELATED APPLICATION

This application claims the benefit of Chinese Patent Application No. 202311369040.9, filed on Oct. 20, 2023, which is incorporated herein by reference in its entirety.

### BACKGROUND OF THE INVENTION

### 1. Field of the Invention

The present invention relates to the field of wireless charging, and particularly to a wireless charging device.

### 2. Description of the Related Art

In recent years, wireless charging technology has become a focus of interest as the popularity of mobile devices and the need for portability continues to grow. Wireless charging technology is a technology that transmits power without using connectors or metal contacts as a medium. Currently, many mobile devices on the market may have uneven surfaces due to their design, for example, the camera of some smartphones protrudes from the back of the phone, resulting in a poor fit when the device to be charged with wireless charging capability is placed on the wireless charger. When the device to be charged does not fit well with the wireless charger, the charging efficiency will be reduced.

### BRIEF DESCRIPTION OF THE INVENTION

In view of this, an embodiment of the present disclosure provides a wireless charging device that may solve the above problems in the prior art.

An embodiment of the present disclosure provides a wireless charging device the a wireless charging device comprises a housing, with a mounting cavity, a top wall of the housing is provided with a bearing surface configured to bear a device to be charged, the top wall of the housing further is provided with at least one mounting hole, and the mounting hole communicating the bearing surface with the mounting cavity; and at least one floating charging assembly, movably arranged in the mounting hole, the floating charging assembly comprises a support plate, an power transmission coil and a magnetic element, the support plate is provided with an outer side and an inner side disposed opposite to each other, the outer side of the support plate being configured to be opposite to the device to be charged, the power transmission coil and the magnetic element are arranged at the inner side of the support plate; wherein the wireless charging device is configured such that, when the wireless charging device is not subjected to an external force, outer surface of the support plate is aligned with or lower than the bearing surface; the magnetic element is configured to be attracted to the device to be charged placed on the bearing surface so that outer surface of the support plate is brought into contact with the device to be charged.

In some embodiments, the wireless charging device further comprises a reset element, connected to the floating charging assembly and configured to align the outer surface of the support plate with or below the bearing surface.

In some embodiments, wherein the reset element comprises at least one elastic element, and the elastic element elastically connects the floating charging assembly and the housing.

In some embodiments, wherein the elastic element comprises an elastic ring, the clastic ring is provided with an inner edge and an outer edge coaxially arranged, the support plate is fixed to the inner edge, the outer edge is fixed to an inner surface of the top wall, and the elastic ring is coaxially arranged with the mounting hole.

In some embodiments, wherein the housing comprises an upper housing and a lower housing which are arranged oppositely, the lower housing is connected to the upper housing, the top wall of the housing is arranged on the upper housing, one side of the lower housing opposite to the upper housing is provided with a first limiting platform protruding, the first limiting platform presses the outer edge against the top wall.

In some embodiments, wherein the elastic ring is provided with a bent portion, one end of the bent portion is connected to the inner edge, the other end of the bent portion is connected to the outer edge, and the bent portion is bent in a direction away from the bearing surface with respect to the inner edge and the outer edge; the outer edge is provided with a plurality of positioning holes, and the inner surface of the top wall has a plurality of positioning blocks protruding, each of the positioning blocks is inserted into a corresponding one of the plurality of positioning holes.

In some embodiments, wherein the rigidity of the support plate is greater than that of the elastic ring, and the elastic ring is integrally formed with the support plate.

In some embodiments, wherein the elastic element is a spring, one end of the spring is connected to the support plate, and the other end of the spring extends in a direction perpendicular to the support plate and is connected to the housing.

In some embodiments, wherein the supporting plate is provided with a first end and a second end opposite to each other in a direction perpendicular to the bearing surface, the first end is rotatably connected with the housing, a rotating shaft of the supporting plate is perpendicular to the axis of the mounting hole, and the elastic element is connected to the second end.

In some embodiments, wherein in the mounting cavity is provided with a second limiting platform, the second limiting platform is arranged opposite to the floating charging assembly, and when the floating charging assembly contacts with the second limiting platform, the outer surface of the supporting plate is aligned with the bearing surface.

In some embodiments, wherein an edge of the supporting plate is provided with a third limiting platform, and the third limiting platform is opposite to the inner surface of the top wall so as to prevent the floating charging assembly from escaping from the mounting hole; when the third limiting platform is in contact with the inner surface of the top wall, the outer surface of the support plate protrudes from the bearing surface.

In some embodiments, wherein the number of the at least one floating charging assembly is multiple; at least one of the multiple mount holes is provide with a plurality of the floating charging assemblies, or the top wall is provided with a plurality of the mounting holes and each of the mounting hole is provided with at least one of the floating charging assemblies.

In some embodiments, the wireless charging device further comprises a control circuit board, arranged in the mounting cavity and on the lateral side of the mounting hole, wherein the control circuit board is electrically connected to the power transmission coil.

In some embodiments, wherein the floating charging assembly further comprises a mounting plate, connected to the support plate and arranged at the inner side of the support plate; wherein the power transmission coil is connected to the mounting plate and arranged between the mounting plate and the support plate.

In some embodiments, wherein the floating charging assembly further comprises a magnetic sheet, arranged between the power transmission coil and the mounting plate, wherein a projection of the magnetic sheet on a plane where the power transmission coil is located covers the power transmission coil.

In accordance with the abovementioned wireless charging device, At least one floating charging component is arranged in the wireless charging device, the floating charging component comprises a supporting plate, an power transmission coil and a magnetic element, the top wall of a housing is provided with at least one mounting hole, and the floating charging component is movably arranged in the mounting hole, so that when device to be charged is placed on a bearing surface of the top wall, the magnetic element is able to attract the device to be charged so that the outer surface of the supporting plate contacts with the device to be charged, so that ensure that the power transmission coil and the device to be charged be aligned with each other and the distance between them is small, thereby ensuring the wireless charging rate. Moreover, the embodiment of the present disclosure ensures the aesthetics of the wireless charging device by setting the wireless charging device in such a way that the outer surface of the support plate is aligned with or lower than the carrying surface when no external force is applied to the wireless charging device, which is conducive to broadening the scope of application of the wireless charging device.

### BRIEF DESCRIPTION OF THE DRAWINGS

FIG. 1 is a three-dimensional structural view of the wireless charging device of the embodiment of the present disclosure.

FIG. 2 is a top view of the wireless charging device according to the embodiment of the present disclosure.

FIG. 3 is an exploded structure diagram of a wireless charging device according to an embodiment of the present disclosure;

FIG. 4 is another exploded structural diagram of a wireless charging device according to an embodiment of the present disclosure;

FIG. 5 is a schematic diagram of an internal structure of a wireless charging device according to an embodiment of the present disclosure;

FIG. 6 is a schematic diagram of the wireless charging apparatus in an embodiment of the present disclosure when charging the device to be charged;

FIG. 7 is a partial enlarged schematic view of a part B of the wireless charging device according to an embodiment of the present disclosure;

FIG. 8 is a partial enlarged schematic view of a part C of the wireless charging device according to an embodiment of the present disclosure;

FIG. 9 is a schematic diagram of the connection between the elastic ring and the supporting plate of the wireless charging device according to an embodiment of the present disclosure;

FIG. 10 is an exploded structural diagram of a wireless charging device according to another embodiment of the present disclosure;

FIG. 11 is another exploded structural diagram of a wireless charging device according to another embodiment of the present disclosure;

FIG. 12 is a schematic diagram of an internal structure of a wireless charging device according to another embodiment of the present disclosure;

FIG. 13 is a schematic view of a wireless charging device according to another embodiment of the present disclosure when the floating charging assembly is lifted;

FIG. 14 is a schematic diagram of an internal structure of a wireless charging device according to another embodiment of the present disclosure;

FIG. 15 is a schematic diagram of a wireless charging apparatus in charging a device to be charged according to another embodiment of the present disclosure;

FIG. 16 is a schematic diagram of an internal structure of a wireless charging device according to another embodiment of the present disclosure;

FIG. 17 is a top view of a wireless charging device of another embodiment of the present disclosure;

FIG. 18 is a top view of the wireless charging device of another embodiment of the present disclosure.

### DETAILED DESCRIPTION OF EMBODIMENTS OF THE INVENTION

Several preferred embodiments of the present disclosure will be described in detail in conjunction with the accompanying drawings as follows, however, the present disclosure is intended to encompass any substitutions, modifications, equivalents, etc., made thereto without departing from the spirit and scope of the present disclosure. In order to provide those skilled in the art with thorough understanding of the present disclosure, particular details will be described below in the preferred embodiments of the present disclosure, although those skilled in the art can understand the present disclosure without the description of these details.

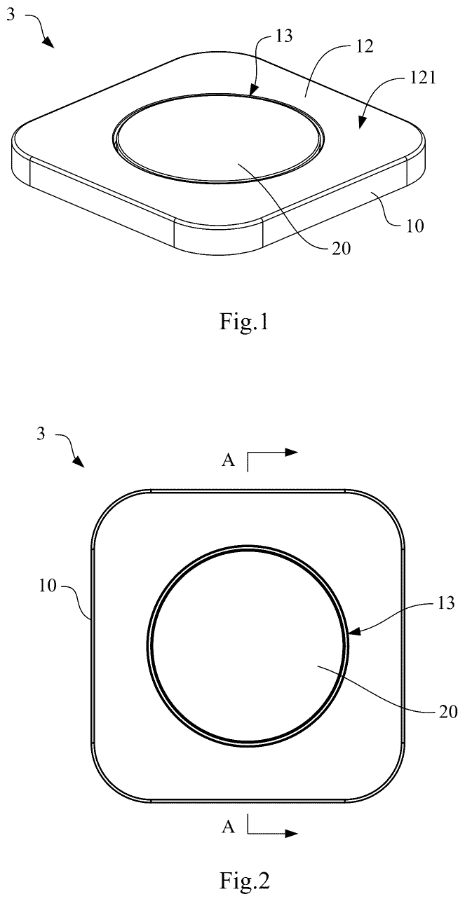

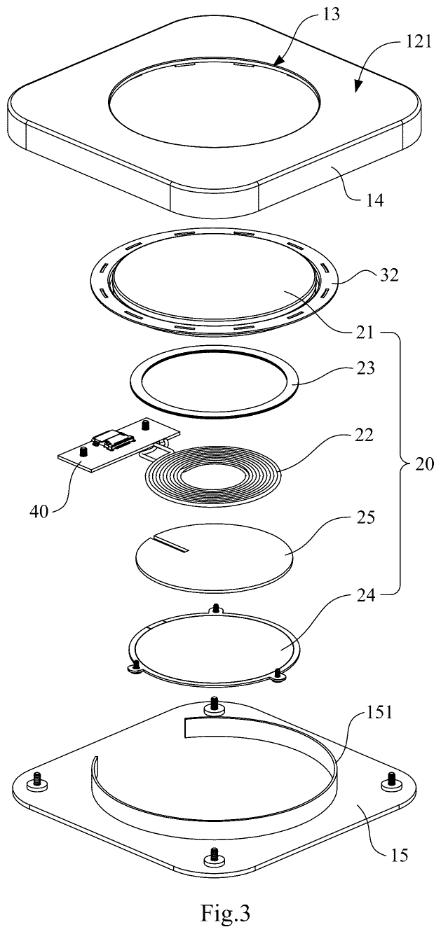

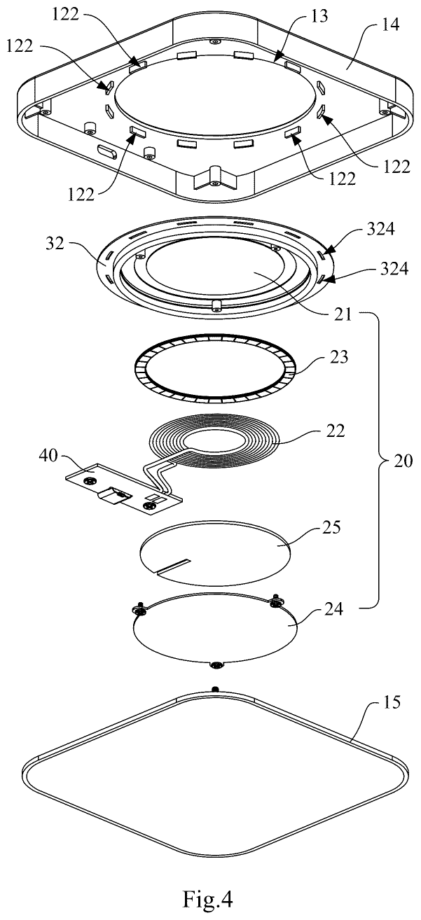

Referring to FIGS. 1 and 2, the wireless charging device 3 of the embodiment of the present disclosure comprises a housing 10 and a floating charging assembly 20. A top wall 12 of the housing 10 has a bearing surface 121, and the bearing surface 121 is used for bearing the device to be charged 1 when the device to be charged 1 is charged by using the wireless charging device 3. The top wall 12 of the housing 10 is provided with a mounting hole 13. The floating charging assembly 20 is arranged in the mounting hole 13 and is movable along the mounting hole 13 within a predetermined range. For example, the floating charging assembly 20 may partially protrude from the bearing surface 121 or descend below the bearing surface 121 along the mounting hole 13 when moving relative to the mounting hole 13. FIGS. 3 and 4 are exploded views of the wireless charging device 3 according to one embodiment of the present disclosure viewed from two different angles. As shown in FIGS. 3 and 4, the floating charging assembly 20 comprises a power transmission coil 22, and the power transmission coil 22 is used to couple with the device to be charged 1 with wireless charging capability to realize wireless electric energy transmission.

The wireless charging device 3 further comprises a control circuit board 40, which is electrically connected to the electrical energy transmission coil 22 and is used to control the electrical energy transmission of the wireless charging device 3. The control circuit board 40 is arranged in the mounting cavity 11, and the housing 10 may protect the control circuit board 40. Optionally, the control circuit board 40 may be disposed laterally of the mounting hole 13. For example, the control circuit board 40 may be fixed to the top wall 12 of the housing 10 by screws, so as to facilitate connection with the electrical energy transmission coil 22. The connection structure between the control circuit board 40 and the electrical energy transmission coil 22 has a certain flexibility, so as to adapt to the up and down floating of the electrical energy transmission coil 22 along the mounting hole 13, and avoid falling off or breaking of the connection between the control circuit board 40 and the electrical energy transmission coil 22. The control circuit board 40 may also be provided with an electrical connector, and the housing 10 is provided with an opening at a position corresponding to the electrical connector, and the electrical connector is aligned with the opening. The electrical connector is used to be electrically connected to an external power input device or line to obtain the electrical energy required for the operation of the wireless charging device 3.

In the embodiment of the present disclosure, the wireless charging device 3 may be implemented as a movable device, for example, may be implemented as a portable charger or may be integrated into other movable equipment; or, the wireless charging device 3 may be implemented as or disposed in a fixed facility, for example, the wireless charging device 3 may be implemented as a part of a building. In the embodiment of the present disclosure, the wireless charging device 3 is described as a small portable charger for charging a portable electronic device such as a mobile phone, but the embodiment of the present disclosure does not limit the specific implementation form of the wireless charging device 3.

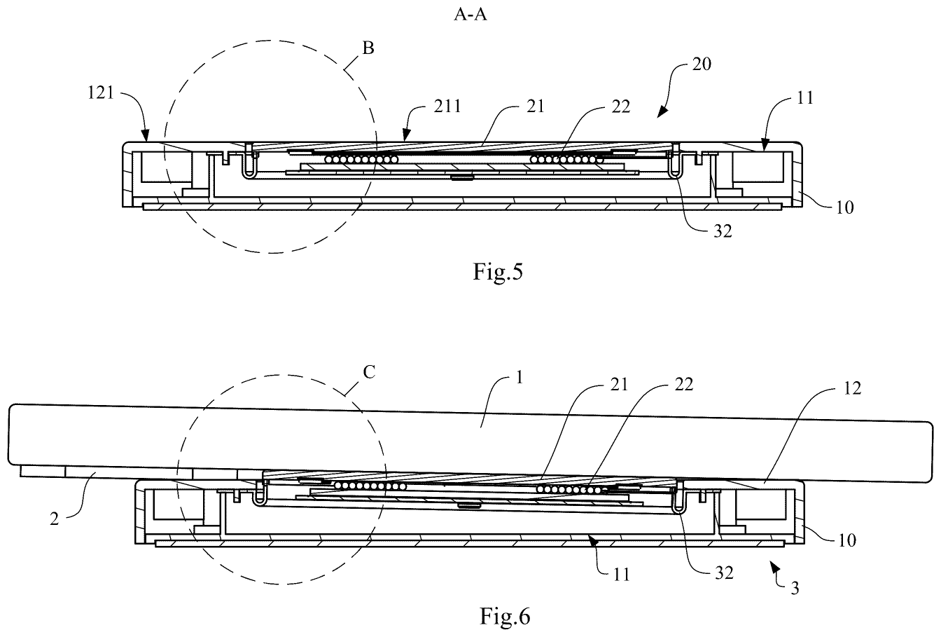

The position of the cross-section of the wireless charging device 3 in FIG. 5 is the plane A-A in FIG. 2, and the position of the cross-section in FIG. 6 is also similar to the plane A-A in FIG. 2, wherein FIG. 5 shows a state when the device to be charged 1 is not placed on the wireless charging device 3, and FIG. 6 shows a state when the device to be charged 1 is placed on the wireless charging device 3. Referring to FIG. 5 and FIG. 6, the housing 10 has a mounting cavity 11, and the mounting hole 13 communicates the mounting cavity 11 with the bearing surface 121. The floating charging assembly 20 further comprises a supporting plate 21 with an outer side and an inner side opposite to each other. The outer side of the supporting plate 21 is a side of the supporting plate 21 exposed to the outside of the wireless charging device 3 through the mounting hole 13, and the inner side of the supporting plate 21 is a side close to the mounting cavity 11. As shown in FIG. 6, when the device to be charged 1 is placed on the bearing surface 121, the outer side of the supporting plate 21 is opposite to the device to be charged 1, and the power transmission coil 22 is disposed on the inner side of the supporting plate 21 and may be located in the mounting cavity 11.

Optionally, the support plate 21 has a certain rigidity to ensure the support capacity and stability of the floating charging assembly 20. The support plate 21 may be made of a polymer material having good wear resistance, electrical insulation and aging resistance. For example, the support plate 21 may be made of polycarbonate (PC), acrylonitrile-butadiene-styrene (ABS) plastic or other materials.

As shown in FIG. 3 to FIG. 6, the floating charging assembly 20 further comprises a magnetic element 23, and the magnetic element 23 is used to magnetically attract the device to be charged I placed on the bearing surface 121. For example, the magnetic element 23 may be a magnet, and the magnetic element 23 may attract a magnetizable metal element in the device to be charged 1. The magnetic element 23 may be arranged at an inner side of the support plate 21, and may be arranged in the mounting cavity 11. In one embodiment, the magnetic element 23 may be fixed to the inner surface of the support plate 21 by adhesive bonding. In some application scenarios, some devices to be charged 1 are provided with magnetizable metal piece arrays or magnet arrays arranged in a predetermined manner, and the arrangement manner of the magnetic elements 23 in the wireless charging device 3 may be set according to the magnetizable metal piece arrays or magnet arrays in the devices to be charged 1, so as to facilitate positioning of the devices to be charged 1 when placed on the wireless charging device 3. In the process of installing the wireless charging device 3, the relative position between the magnetic element 23 and the power transmission coil 22 may need to be well positioned, so that when the magnetic element 23 is attracted to the device to be charged 1, the receiving coil in the device to be charged 1 is able to be aligned with the power transmission coil 22 in the wireless charging device 3, and the electric energy transmission effect is ensured.

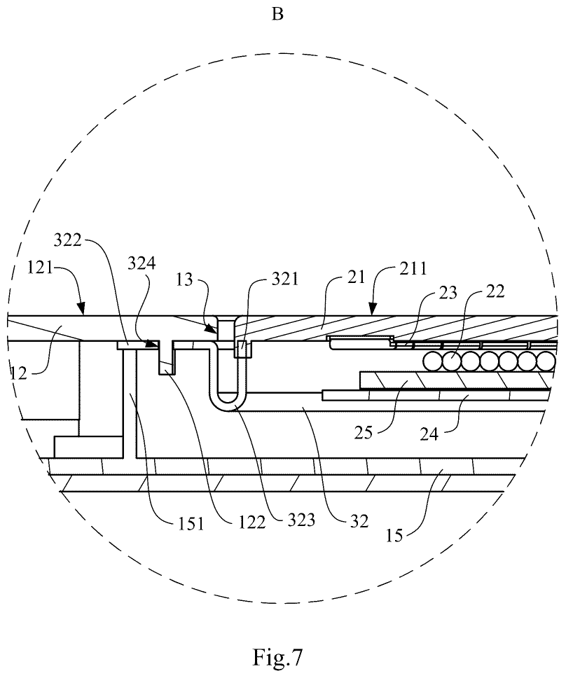

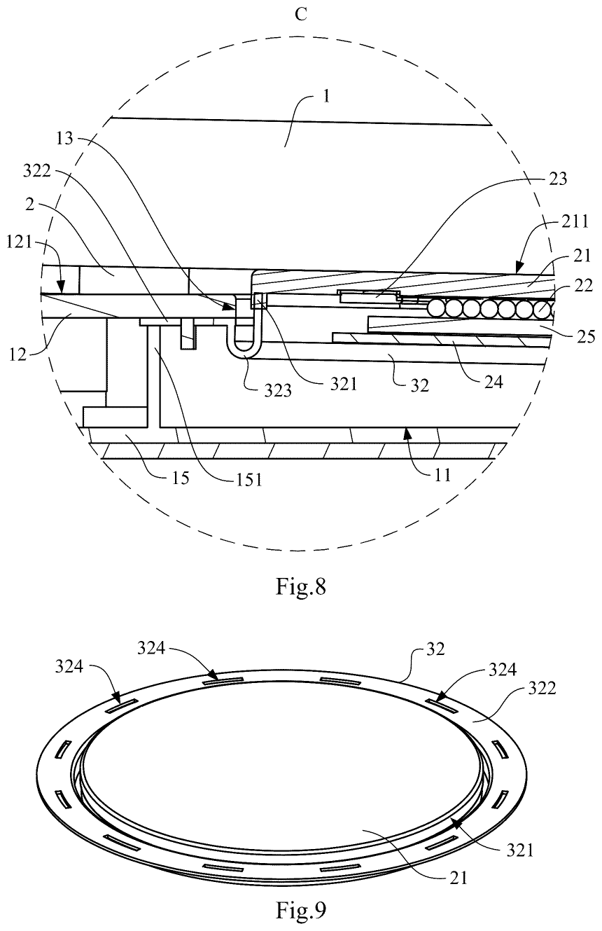

FIG. 7 is a partial enlarged view of a portion B in FIG. 5, and FIG. 8 is a partial enlarged view of a portion C in FIG. 6. FIG. 7 and FIG. 8 respectively show the relative positional relationship between the floating charging assembly 20 and the bearing surface 121 when the wireless charging device 3 does not bear the device to be charged 1 and when the wireless charging device 3 bears the device to be charged 1. Referring to FIG. 5 and FIG. 7, in the embodiment of the present disclosure, the wireless charging device 3 is configured such that outer surface 211 of the supporting plate 21 is aligned with or lower than the bearing surface 121 when the wireless charging device 3 is not subjected to an external force, so that the surface of the wireless charging device 3 is relatively flat, which is beneficial to improving the aesthetic appearance of the wireless charging device 3. As shown in FIG. 6 and FIG. 8, when the device to be charged 1 is placed on the bearing surface 121 for wireless charging, the magnetic element 23 assists in aligning the device to be charged 1 with the power transmission coil 22, and at the same time, due to the mutual attraction between the magnetic clement 23 and the device to be charged 1, the floating charging assembly 20 is lifted under the action of magnetic attraction, so that outer surface 211 of the supporting plate 21 protrudes from the bearing surface 121 and is close to or even attached to the surface of the device to be charged 1. Thus, it reducing the distance between the power transmission coil 22 and the device to be charged 1, and ensuring the power transmission efficiency.

In some application scenarios, the back side of the device to be charged 1 is provided with a protruding structure. For example, referring to FIG. 6 and FIG. 8, the camera 2 module on the back of some mobile phones may protrude from the rear end surface of the mobile phone. When such a device to be charged 1 is placed on the bearing surface 121, a gap may be generated between the device to be charged 1 and the wireless charging device 3. As shown in FIG. 8, by using the wireless charging device 3 according to the embodiment of the present disclosure, when the device to be charged 1 is placed on the bearing surface 121, the floating charging assembly 20 is able to automatically rise under the action of the magnetic attraction force to be attached to the device to be charged 1, and the movable floating charging assembly 20 may fully adapt to the gaps with different sizes formed between the floating charging assembly 20 and the wireless charging device 3 due to the different specifications or placement postures of the device to be charged 1. When the wireless charging device 3 is not subjected to an external force, the outer surface 211 of the supporting plate 21 is aligned with or lower than the bearing surface 121 rather than protruding from the bearing surface 121, so that the device to be charged 1 with a relatively flat surface may be well attached to the floating charging assembly 20 when placed on the bearing surface 121. Thus, the wireless charging device 3 is applicable to the wireless charging of not only the device to be charged 1 with a protruding structure, but also the device to be charged 1 with a relatively flat surface, so the wireless charging device 3 has a relatively wide application range.

In some embodiments, the floating charging assembly 20 further comprises a mounting plate 24 that may be used for mounting of the power transmission coil 22. A predetermined spacing is defined between the support plate 21 and the mounting plate 24, the mounting plate 24 is connected to the support plate 21 and is disposed at an inner side (i.e., a lower side in FIGS. 5 to 8) of the support plate 21. For example, the mounting plate 24 may be connected to the support plate 21 by screws. The power transmission coil 22 is connected to the mounting plate 24 and arranged between the mounting plate 24 and the support plate 21. Providing the mounting plate 24 may support the power transmission coil 22 well and prevent the power transmission coil 22 from shifting or falling off.

Optionally, the floating charging assembly 20 further comprises a magnetic sheet 25, the magnetic sheet 25 is disposed on one side of the mounting plate 24, which is close to the power transmission coil 22, and the projection of the magnetic sheet 25 on the plane where the power transmission coil 22 is located covers the power transmission coil 22. The wireless charging device 3 charges the device to be charged 1 by electromagnetic induction, and the magnetic sheet 25 is beneficial to enhancing the magnetic field intensity generated by the power transmission coil 22, and may achieve the magnetic field convergence effect, thereby improving the power transmission efficiency.

Optionally, the housing 10 includes an upper housing 14 and a lower housing 15 disposed opposite to each other, and the lower housing 15 is connected with the upper housing 14 to form the mounting cavity 11. The top wall 12 of the housing 10 is provided in the upper case 14, that is, the mounting hole 13 is provided in the upper case 14. The upper shell 14 and the lower shell 15 may be of a separate structure, and the lower end of the upper shell 14 has an opening. When the wireless charging device 3 is assembled, the floating charging assembly 20, the control circuit board 40 and other components can be conveniently installed into the upper shell 14 from the opening, and finally the lower shell 15 is spliced with the upper shell 14 to seal the installation cavity 11.

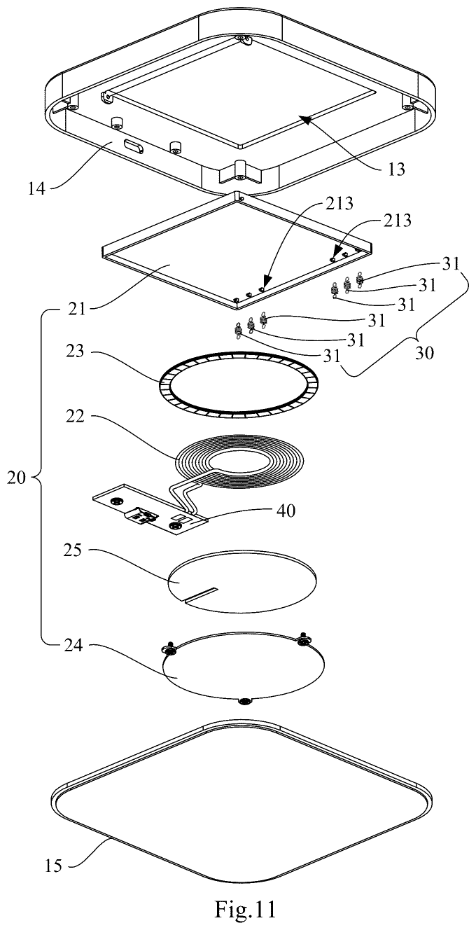

In some embodiments, the wireless charging device 3 further comprises a resetting clement 30, the resetting element 30 is connected to the floating charging assembly 20, and is configured to, after the device to be charged 1 is removed from the bearing surface 121, reset the floating charging assembly 20 protruding from the bearing surface 121 to a position where the outer surface 211 of the supporting plate 21 descends to be aligned with or lower than the bearing surface 121. Referring to FIGS. 3 to 15, in one embodiment, the resetting element 30 may include at least one elastic element connected between the floating charging assembly 20 and the housing 10 to maintain the clastic connection between the floating charging assembly 20 and the housing 10. When the floating charging assembly 20 moves outward along the mounting hole 13 due to the mutual attraction between the floating charging assembly 20 and the device to be charged 1, the elastic element is elastically deformed, and when the device to be charged 1 is removed from the wireless charging apparatus 3, the floating charging assembly 20 is reset under the action of the clastic element. It should be understood that the resetting element 30 is not limited to an elastic clement, and other suitable devices can be selected as the resetting element 30, such as an electric device, a pneumatic device or other devices.

In some embodiments, as shown in FIGS. 3-8, the elastic element comprises an elastic ring 32 disposed coaxially with the mounting hole 13. Referring to FIG. 7, FIG. 8 and FIG. 9, the clastic ring 32 has an inner edge 321 and an outer edge 322 which are coaxially arranged. The support plate 21 is disposed in the middle of the elastic ring 32 and fixed to the inner edge 321, and the outer edge 322 of the elastic ring 32 is fixed to the inner surface of the top wall 12. The rigidity of the elastic ring 32 is smaller than that of the support plate 21, so that the elastic ring 32 is able to be elastically deformed when the floating charging assembly 20 moves along the mounting hole 13. Therefore, the elastic ring 32 establish an elastic connection between the support plate 21 and the housing 10, so as to realize the automatic resetting of the floating charging assembly 20. The elastic ring 32 may be made of an electrically insulating material with good elasticity. For example, in this embodiment, the material of the elastic ring 32 may be thermoplastic polyurethane rubber (TPU), which may ensure that the elastic ring 32 has good tensile strength, tear strength, resilience and wear resistance.

The shape of the elastic ring 32 is set according to the shapes of the mounting hole 13 and the supporting plate 21, so that the elastic ring 32 and the supporting plate 21 may shield the mounting hole 13 after being mounted at the mounting hole 13, which is beneficial to the waterproof and dustproof of the wireless charging device 3. The elastic ring 32 may be flat or have a concavo-convex structure in a natural state without external force. In one embodiment, referring to FIG. 7 and FIG. 8, the elastic ring 32 has a bending portion 323, one end of the bending portion 323 extends to the inner edge 321, and the other end extends to the outer edge 322. The bending portion 323 is bent in a direction away from the bearing surface 121 relative to the inner edge 321 and the outer edge 322 to form a structure with a longitudinal section approximately in a “U” shape. The bent portion 323 is able to support the support plate 21, so that the support plate 21 is able to be moved along the axial direction and reduce lateral shaking. In addition, since the elastic ring 32 may undergo repeated elastic deformation during the use of the wireless charging device 3, the provision of the bent portion 323 is also beneficial to prolonging the service life of the elastic ring 32.

Optionally, the connection between the support plate 21 and the inner edge 321 may be realized by integral molding, for example, the support plate 21 and the elastic ring 32 may be manufactured by a double injection molding process, so that the connection between the support plate 21 and the elastic ring 32 may be more firm.

The connection between the outer edge 322 and the housing 10 may be realized by adhesive bonding, fixing by a connecting piece, hot melt connection or other means. In an optional embodiment, referring to FIG. 3, FIG. 7, and FIG. 8, a side of the lower shell 15 opposite to the upper shell 14 has a protruding first limiting platform 151. The first limiting platform 151 extends in a direction close to the top wall 12 and corresponds to the outer edge 322 of the elastic ring 32. After the lower shell 15 is assembled with the upper shell 14, the first limiting platform 151 presses the outer edge 322 against the top wall 12 to fix the outer edge 322. Referring to FIGS. 4, 7, and 9, optionally, the outer edge 322 may be provided with a plurality of positioning holes 324, the inner surface of the top wall 12 is provided with a plurality of positioning blocks 122 protruding, the shapes of the positioning blocks 122 correspond to the shapes of the positioning holes 324, and the positioning blocks 122 and the positioning holes 324 are in one-to-one correspondence. When the outer edge 322 of the elastic ring 32 is mounted in the housing 10, each positioning block 122 is able to be inserted into the corresponding positioning hole 324, and the positioning blocks 122 and the positioning holes 324 may be connected by interference fit, so as to fix the elastic ring 32 relative to the mounting hole 13 in the radial direction and the circumferential direction. Optionally, as shown in FIG. 7 and FIG. 8, the outer edge 322 and the housing 10 may be fixed not only through the extrusion of the first limiting platform 151 but also through the cooperation between the positioning block 122 and the positioning hole 324, so that the outer edge 322 is stably fixed in the radial direction, the circumferential direction and the axial direction.

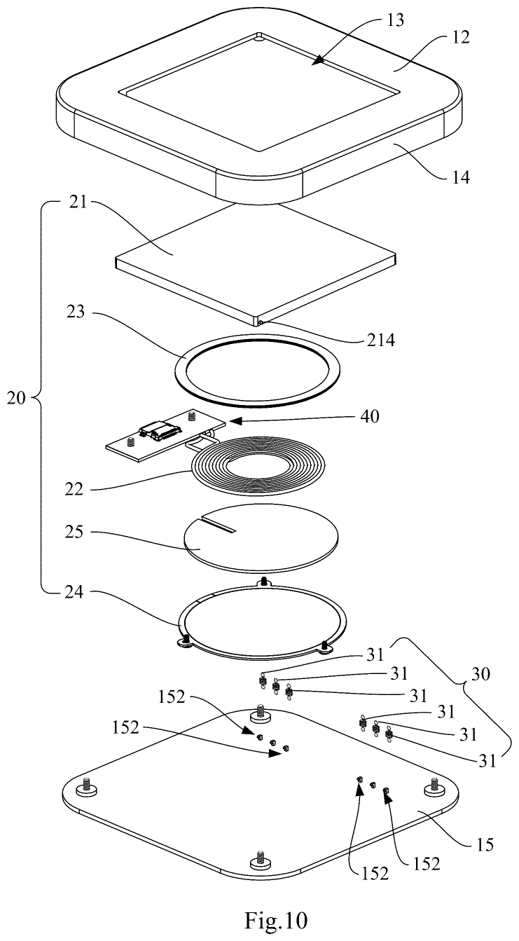

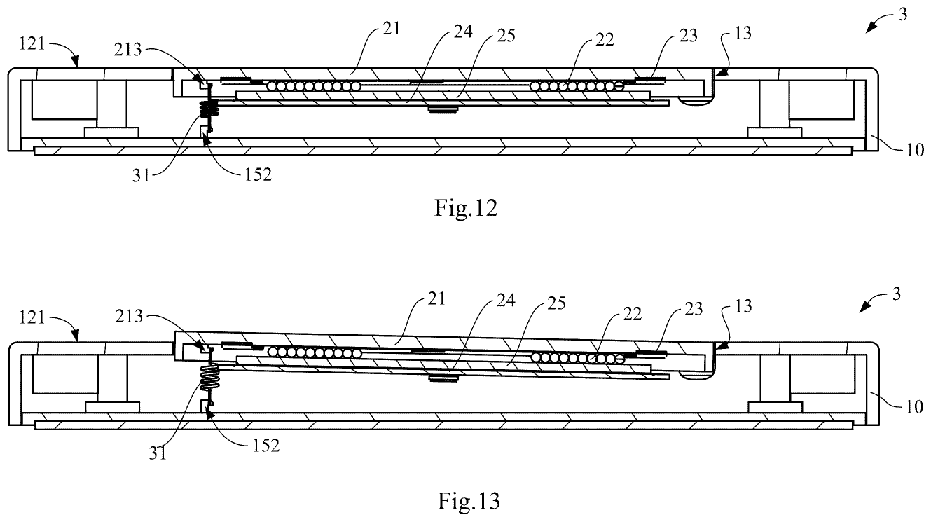

As shown in FIGS. 10-15, in some embodiments, the elastic clement is a spring 31. One end of the spring 31 is connected to the support plate 21, and the other end extends in a direction perpendicular to the support plate 21 and is connected to the housing 10. For example, in FIGS. 12-15, a first mounting hook 213 is disposed on an inner surface of the support plate 21, a second mounting hook 152 is disposed on an upper surface of the lower shell 15 at a position corresponding to the first mounting hook 213, one end of the spring 31 is connected to the first mounting hook 213 of the support plate 21, and the other end of the spring 31 is connected to the second mounting hook 152 at a corresponding position of the lower shell 15. The spring 31 is a tension spring, and the spring 31 applies a downward force to the support plate 21.

The supporting plate 21 has a first end and a second end opposite to each other in a direction perpendicular to the bearing surface 121. In one embodiment, as shown in FIG. 10 to FIG. 13, the first end is rotatably connected to the housing 10, and the rotating shaft 214 of the supporting plate 21 is substantially perpendicular to the axis of the mounting hole 13. For example, in FIG. 12 and FIG. 13, the direction of the rotating shaft 214 is substantially perpendicular to the plane of the drawings. The support plate 21 is able to rotate in the mounting hole 13 around the rotating shaft 214, and the elastic element (e.g., the spring 31 in FIG. 12 and FIG. 13) is connected to the second end. FIG. 12 and FIG. 13 are, respectively, schematic views of the wireless charging device 3 when no external force is applied and the floating charging assembly 20 is lifted during charging. In order to better show the relative position between the floating charging assembly 20 and the bearing surface 121, the device to be charged is not shown in FIG. 13. By comparing FIG. 12 with FIG. 13, it can be known that the first end of the supporting plate 21 is rotatably connected with the housing 10, which can play a role in limiting the position of the support plate 21. The movement of the floating charging assembly 20 has a relatively fixed reference point, so as to prevent the floating charging assembly 20 from dislodging or falling off. The elastic element is disposed at the second end to apply a longer torque to the supporting plate 21, which is beneficial to ensure the resetting effect of the floating charging assembly 20.

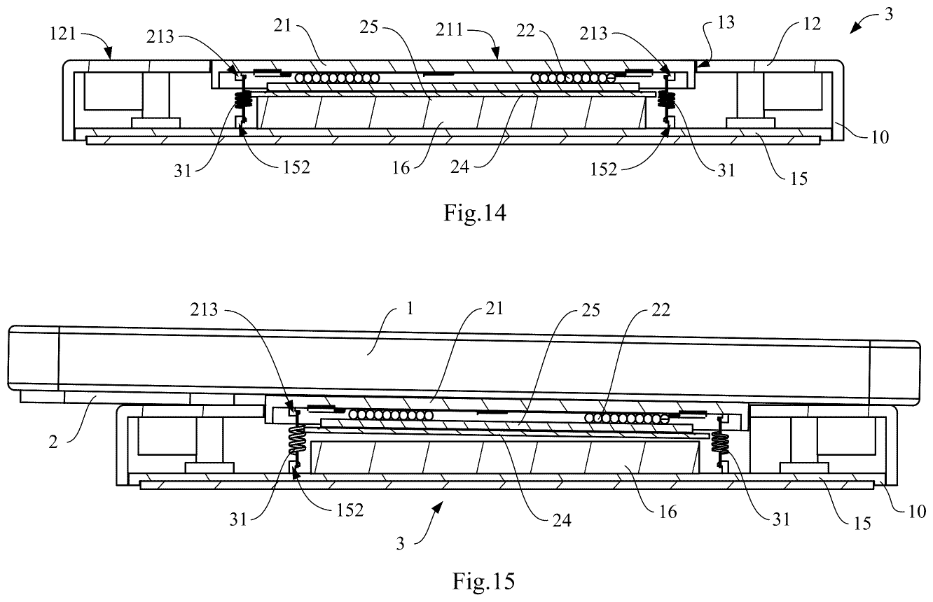

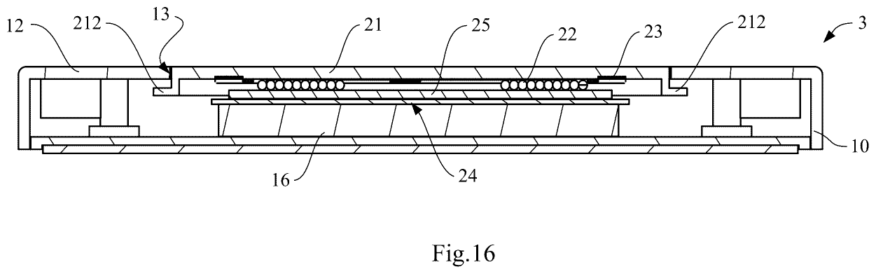

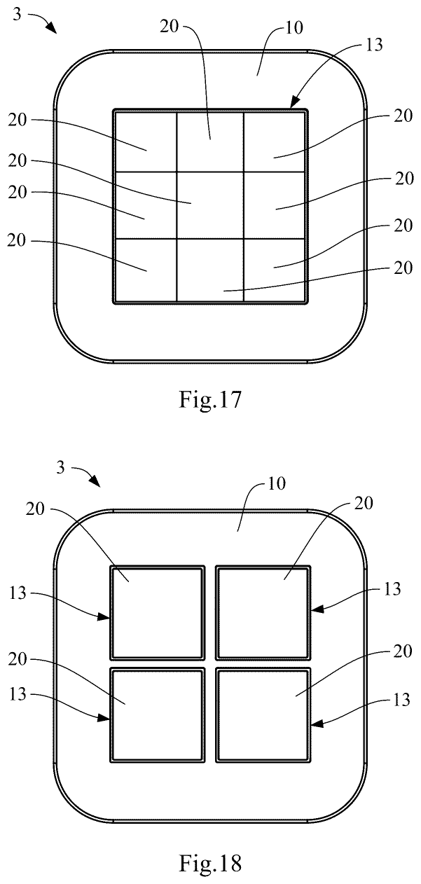

In one embodiment, as shown in FIG. 14 and FIG. 15, the springs 31 may be disposed of at both ends of the supporting plate 21, without the rotating shaft 214 being provided for being rotatably connected with the housing 10. In this way, the supporting plate 21 is able to float up and down, which is beneficial to increase the floating range of the floating charging assembly 20 and facilitate the floating charging assembly 20 to be attached to different devices to be charged 1. The arrangement of the springs 31 makes the two ends of the supporting plate 21 have a balanced force, so as to ensure the stability of the floating charging assembly 20.

In addition, compared with directly arranging the boss on the wireless charging device 3, in the embodiment of the present disclosure, the wireless charging device 3 is arranged such that the outer surface 211 of the supporting plate 21 is aligned with or lower than the bearing surface 121 when the wireless charging device 3 is not subjected to external force, which is more beneficial to improving the aesthetic appearance of the wireless charging device 3 and widening the application range of the wireless charging device 3, so that the wireless charging device 3 not only can be applied to the equipment 1 to be charged with a protruding structure on the surface, it is also applicable to a device 1 to be charged having a relatively flat surface.

The foregoing descriptions of specific embodiments of the present disclosure have been presented for purposes of illustration and description. They are not intended to be exhaustive or to limit the present disclosure to the precise forms disclosed, and obviously, many modifications and variations are possible in light of the above teaching. The embodiments were chosen and described in order to best explain the principles of the present disclosure and its practical application, thereby enable others skilled in the art to best utilize the present disclosure and various embodiments with various modifications as are suited to the particular use contemplated. It is intended that the scope of the present disclosure be defined by the claims appended hereto and their equivalents.

I/We claim:

1. A wireless charging device (3), comprising:
a housing (10), with a mounting cavity (11), a top wall (12) of the housing (10) is provided with a bearing surface (121) configured to bear a device to be charged (1), the top wall (12) of the housing (10) further is provided with at least one mounting hole (13), and the mounting hole (13) communicating the bearing surface (121) with the mounting cavity (11); and
at least one floating charging assembly (20), movably arranged in the mounting hole (13), the floating charging assembly (20) comprises a support plate (21), a power transmission coil (22), and a magnetic element (23), the support plate (21) is provided with an outer side and an inner side disposed opposite to each other, the outer side of the support plate (21) being configured to be opposite to the device to be charged (1), the power transmission coil (22) and the magnetic element (23) are arranged at the inner side of the support plate (21);
wherein the wireless charging device (3) is configured such that, when the wireless charging device (3) is not subjected to an external force, an outer surface (211) of the support plate (21) is aligned with or lower than the bearing surface (121);
the magnetic element (23) is configured to be attracted to the device to be charged (1) placed on the bearing surface (121) so that the outer surface (211) of the support plate (21) is brought into contact with the device to be charged (1).

2. The wireless charging device (3) according to claim 1, further comprising:
a reset element (30), connected to the floating charging assembly (20) and configured to align the outer surface (211) of the support plate (21) with or below the bearing surface (121).

3. The wireless charging device (3) according to claim 2, wherein the reset element (30) comprises at least one elastic element, and the elastic element elastically connects the floating charging assembly (20) and the housing (10).

4. The wireless charging device (3) according to claim 3, wherein the elastic element comprises an elastic ring (32), the elastic ring (32) is provided with an inner edge (321) and an outer edge (322) coaxially arranged, the support plate (21) is fixed to the inner edge (321), the outer edge (322) is fixed to an inner surface of the top wall (12), and the elastic ring (32) is coaxially arranged with the mounting hole (13).

5. The wireless charging device (3) according to claim 4, wherein the housing (10) comprises an upper housing (14) and a lower housing (15) which are arranged oppositely, the lower housing (15) is connected to the upper housing (14), the top wall (12) of the housing (10) is arranged on the upper housing (14), one side of the lower housing (15) opposite to the upper housing (14) is provided with a first limiting platform (151) protruding, the first limiting platform (151) presses the outer edge (322) against the top wall (12).

6. The wireless charging device (3) according to claim 4, wherein the elastic ring (32) is provided with a bent portion (323), one end of the bent portion (323) is connected to the inner edge (321), the other end of the bent portion (323) is connected to the outer edge (322), and the bent portion (323) is bent in a direction away from the bearing surface (121) with respect to the inner edge (321) and the outer edge (322);
the outer edge (322) is provided with a plurality of positioning holes (324), and the inner surface of the top wall (12) has a plurality of positioning blocks (122) protruding, each of the positioning blocks (122) is inserted into a corresponding one of the plurality of positioning holes (324).

7. The wireless charging device (3) according to claim 4, wherein the rigidity of the support plate (21) is greater than that of the elastic ring (32), and the elastic ring (32) is integrally formed with the support plate (21).

8. The wireless charging device (3) according to claim 3, wherein the elastic element is a spring (31), one end of the spring (31) is connected to the support plate (21), and the other end of the spring (31) extends in a direction perpendicular to the support plate (21) and is connected to the housing (10).

9. The wireless charging device (3) according to claim 3, wherein the supporting plate (21) is provided with a first end and a second end opposite to each other in a direction perpendicular to the bearing surface (121), the first end is rotatably connected with the housing (10), a rotating shaft (214) of the supporting plate (21) is perpendicular to the axis of the mounting hole (13), and the elastic element is connected to the second end.

10. The wireless charging device (3) according to claim 1, wherein in the mounting cavity (11) is provided with a second limiting platform (16), the second limiting platform (16) is arranged opposite to the floating charging assembly (20), and when the floating charging assembly (20) contacts with the second limiting platform (16), the outer surface (211) of the supporting plate (21) is aligned with the bearing surface (121).

11. The wireless charging device (3) according to claim 1, wherein an edge of the supporting plate (21) is provided with a third limiting platform (212), and the third limiting platform (212) is opposite to the inner surface of the top wall (12) so as to prevent the floating charging assembly (20) from escaping from the mounting hole (13);
when the third limiting platform (212) is in contact with the inner surface of the top wall (12), the outer surface (211) of the support plate (21) protrudes from the bearing surface (121).

12. The wireless charging device (3) according to claim 1, wherein the number of the at least one floating charging assembly (20) is multiple;
at least one of the multiple mount holes (13) is provide with a plurality of the floating charging assemblies (20), or the top wall (12) is provide with a plurality of the mounting holes (13) and each of the mounting hole (13) is provided with at least one of the floating charging assemblies (20).

13. The wireless charging device (3) according to claim 1, further comprises:
a control circuit board (40), arranged in the mounting cavity (11) and on the lateral side of the mounting hole (13), wherein the control circuit board (40) is electrically connected to the power transmission coil (22).

14. The wireless charging device (3) according to claim 1, wherein the floating charging assembly (20) further comprises:
a mounting plate (24), connected to the support plate (21) and arranged at the inner side of the support plate (21);
wherein the power transmission coil (22) is connected to the mounting plate (24) and arranged between the mounting plate (24) and the support plate (21).

15. The wireless charging device (3) according to claim 14, wherein the floating charging assembly (20) further comprises:
a magnetic sheet (25), arranged between the power transmission coil (22) and the mounting plate (24), wherein a projection of the magnetic sheet (25) on a plane where the power transmission coil (22) is located covers the power transmission coil (22).
